(19) United States
(12) Patent Application Publication
(10) Pub. No.: US 2014/0179470 A1
(43) Pub. Date: Jun. 26, 2014

(54) DEVICE FOR A BICYCLE PROVIDED WITH CHAIN WHEELS AND SPROCKETS

(71) Applicant: Franck Jean Savard, Saint Martin De Re (FR)

(72) Inventor: Franck Jean Savard, Saint Martin De Re (FR)

(21) Appl. No.: 14/238,281

(22) PCT Filed: Aug. 18, 2011
(86) PCT No.: PCT/FR2011/051933

§ 371 Date: Feb. 11, 2014

(30) Foreign Application Priority Data
Aug. 24, 2010 (FR) 10 03442

(51) Int. Cl. B62M 9/124; B62M 9/134

(52) U.S. Cl. CPC B62M 9/124; B62M 9/134
USPC 474/80

(57) ABSTRACT

A device (10) for a bicycle provided with chain wheels (14) and sprockets (16), a chain stretched between the chain wheels (14) and sprockets (16), and a rear derailleur (DR), the device (10) including a housing (20) containing: chain wheel (14) shifting elements (26) that include direct control of a fork (42) and form a front derailleur (DA); elements (28) for shifting the sprockets (16) via the rear derailleur (DR); and elements (30) for controlling the chain wheel (14) shifting elements (26) and the sprocket (16) shifting elements (23).

This invention relates to a single device for shifting gears on a bicycle equipped with chain wheels and sprockets.

Bicycles are equipped, for the most part, with two derailleurs, front and rear, with a drive chain stretched between these two derailleurs.

This system, known for a long time, may seem obsolete, but that is not the case at all because it involves an arrangement of very great simplicity for industrial manufacturing, great reliability, and entirely reasonable cost.

An assembly of known type generally comprises at least two front chain wheels and a maximum of three chain wheels and a front derailleur, DA, able to transfer the chain from one to the other by a so-called derailing operation. These chain wheels are mounted on the axis of rotation of the pedaling cranks.

This known assembly also comprises a rear sprocket cassette, mounted on the shaft of the rear wheel, comprising generally 1 to 9 sprockets, with a free wheel mechanism inserted between the shaft and the cassette to be able to stop the pedaling and to take advantage of the rolling inertia.

The chain passes over this cassette as over the chain wheels, and a rear derailleur, DR, is tasked with making the chain derail from one sprocket to another.

Consequently, it is understood that there are a very large number of gears, equal to the product of the number of chain wheels by the number of sprockets or 27 gears for an arrangement having 3 chain wheels and 9 sprockets.

This very large number of gears results in redundancies and gears are found to be detrimental to efficient operation, all the more so since there are gears.

Actually, the gears that are governed by a major chain crossing should never be used because, on the one hand, they are not very productive because they create losses due to friction and, on the other hand, they are dangerous because they cause breakages of the chains during forces exerted with the chain crossed and at the very least very premature wear of said chain generally.

Consequently, it is understood that if gears must be eliminated, choices must therefore be made and that if two levers have to be operated, the attention of the cyclist quickly becomes diverted by these operations at the expense in particular of safety and at the very least of the pleasure of riding.

These reasons in particular are the ones that have led numerous cyclists not to equip their bicycles with such sophisticated and so useful equipment.

Also, numerous solutions have been devised over time to preserve the very widespread, existing equipment of the two derailleurs with more or fewer chain wheels and sprockets but simplifying the operating and eliminating the unwanted gears.

In particular, it has been conceived to have only a single control for the two derailleurs by synchronizing the operations of the two derailleurs, simultaneously.

Thus, the U.S. Pat. No. 4,201,095 (Cirami) is known, which patent had envisioned a single control but with the drawback that the desired progressivity did not exist because at the same time that a chain wheel derailing is caused, which results in a sharp shifting of the gear, it is also necessary to reduce the gear by a derailing of sprockets in the reverse direction so as to compensate for this excessive separation.

The patent EP 727348 (Savard) provided an elegant solution to the problem that gave rise to a marketing of a product under the name of Synchroshift. It involves a monocontrol, incorporated in the handgrip, for example by means of a mechanism that rotates with two tracks with sliders circulating in these tracks that pull or push the cables of the front derailleur DA and the rear derailleur DR.

This solution has been supplemented by an arrangement in the form of a case fastened to the frame, as the French patent FR 2 860 208 (Savard) teaches.

The drawback of these arrangements is the path of cables that remains tortuous and that makes the controls a bit difficult, the main drawback being the relatively bulky characteristic that puts a curb on marketing and integration. Moreover, it has been duly pointed out that the drive with chain and two derailleurs had a long past but also has a future because of the simplicity and reliability of the arrangement; therefore, a single device is needed for shifting gears on a bicycle having two derailleurs that is compact, that ensures a pulling of the cables in as straight a manner as possible so as to make possible a flexible operation, and especially that these arrangements are intended for the majority of people, therefore not necessarily for athletes and those experienced with the bicycle, and thus a very gentle operation is needed.

Finally, a number of extremely scaled-down parts are needed to guarantee a certain reliability, an excellent accessibility for any repair, parts that can be made by molding, particularly composite molding, so as to reduce costs and to make the device lighter.

This is the object of the device according to this invention to respond to these needs while making possible the simultaneous derailing operation of the chain wheels and sprockets to make it possible to take advantage only of the gears that are useful and not redundant, this from the smallest to the largest with a progressivity and with a limited crossing of the chain.

This invention is now described with regard to the accompanying drawings that show a particular, nonlimiting embodiment, with the figures of these drawings showing respectively:

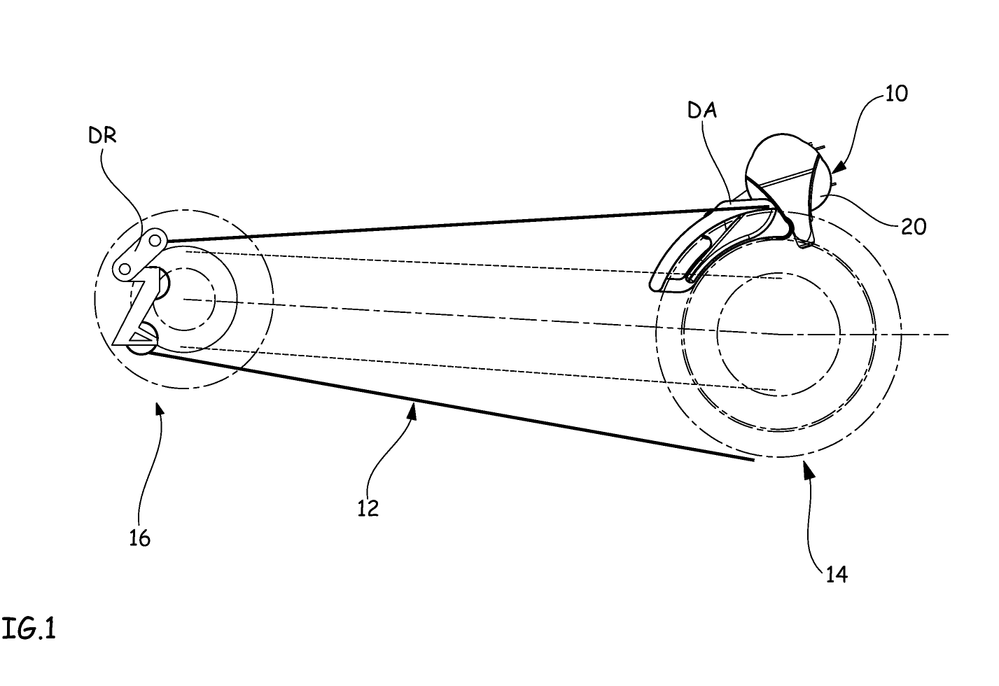

FIG. 1: a diagrammatic view of a drive by chain stretched between chain wheels and sprockets, equipped with a front derailleur and a rear derailleur as well as the device for shifting gears according to the invention,

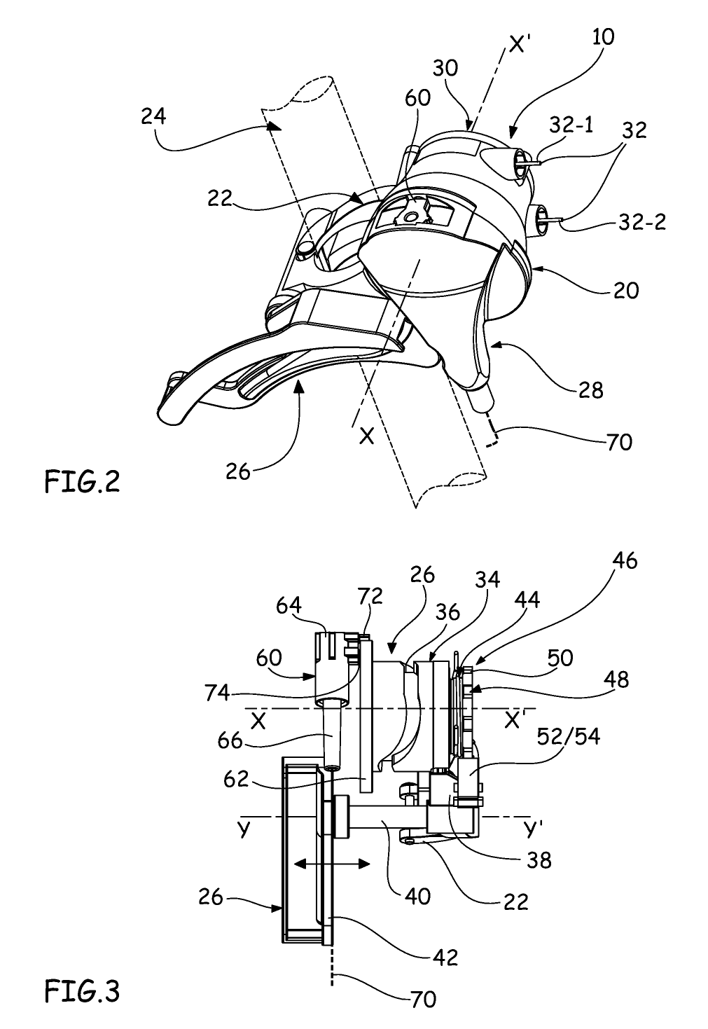

FIG. 2: a view in perspective of a device for shifting gears according to the invention,

FIG. 3: a view of the back of the device for shifting gears according to the invention with the casing removed,

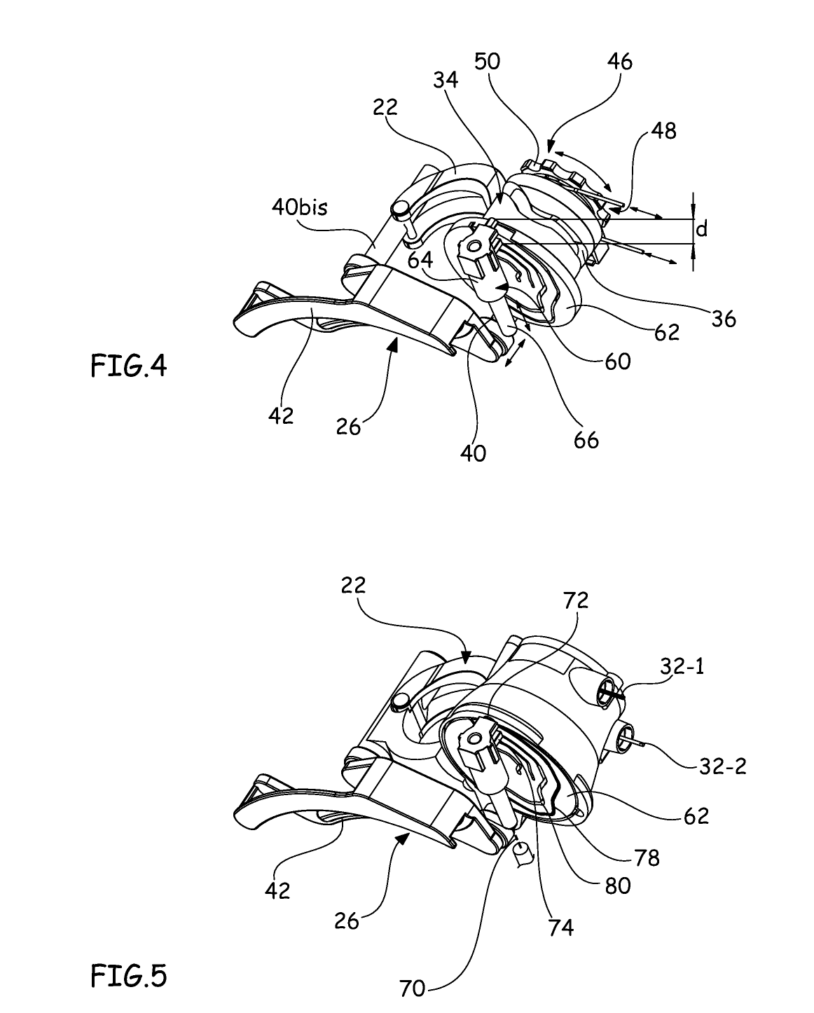

FIG. 4: a view in perspective of the device for shifting gears according to the invention with the casing removed,

FIG. 5: a view of the device for shifting gears according to the invention with the casing in place except for the exterior lateral face on the fork side of the front derailleur,

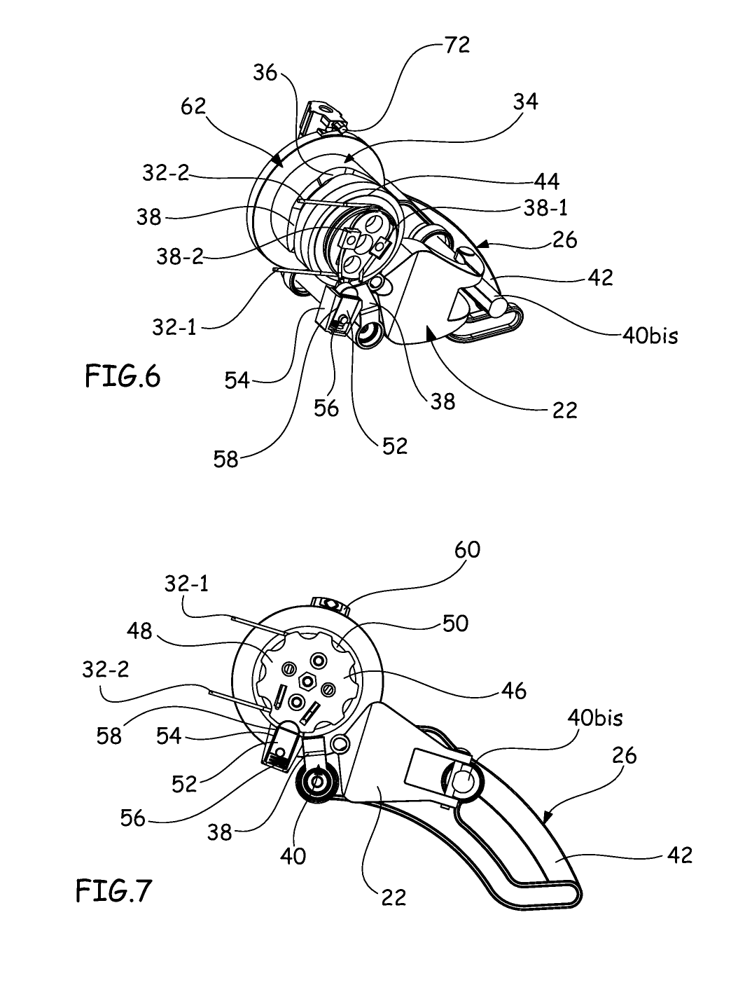

FIG. 6: a view in perspective of the device for shifting gears according to the invention with the control coming from the hanger, the general casing and the indexing having been removed,

FIG. 7: a lateral front view of the device for shifting gears according to the invention with the general casing removed and the indexing in place, and in FIG. 1, a device 10 for shifting gears of a bicycle as well as a rear derailleur DR, of known type, and a chain 12 are shown.

This chain drives an assembly 14 of chain wheels and a sprocket cassette 16.

A front derailleur DA of the prior art comprises, in a known way, a fork into which the chain passes, this fork being mounted on a deformable parallelogram; it is moved in translation perpendicular to the plane of the frame so as to place the chain in line with each chain wheel desired by the user.

The control of this sole front derailleur DA ensures the pulling on the parallelogram to move it from a position in line with the small-diameter chain wheel to a position in line with the larger-diameter chain wheel, while passing by the intermediate chain wheel when it is provided with one. A return spring makes possible the return to the small-diameter chain wheel when the control is guided in this direction by the user. The force is authorized by the user to transfer the chain from the small-diameter chain wheel to the larger-diameter chain wheel, in opposition to the return spring.

In the same way, for the rear derailleur DR, in a known way the control associated with this derailleur makes it possible for the user to transfer the chain from the smaller-diameter sprocket to the larger-diameter sprocket while passing by all of the sprockets of the cassette. A return spring brings the chain back onto the small sprocket when the control allows it there at the request of the user. The force is authorized by the user to transfer the chain from the smaller sprocket to the greater-diameter sprocket, in opposition to the return spring.

The device for shifting gears according to this invention comprises a case 20, mounted in a known way by a collar 22 on the frame 24 of the bicycle and on the seat tube preferably, as are the front derailleurs DA of the prior art. The object is in effect to maintain the prior arrangement in a general way so as to be able to ensure a retrofit mounting as well as an original-equipment mounting on new bicycles.

The case 20 is then found approximately in line with the crankset, not shown, a bit downstream in relation to the direction of advance of the bicycle that is equipped, therefore slightly upstream from the apex of the chain on the chain wheels and therefore upstream from the engagement of the links of the chain on the cogs of the chain wheels.

This case 20 comprises means 26 for changing chain wheels and means 28 for changing sprockets as well as means 30 for control of said means 26 for changing chain wheels and said means 28 for changing the sprockets, these control means 30 being able to be operated by the user.

The means 32 for operating these control means can be mechanical in the form of a rotating handle or of a ratchet lever or in hydraulic form with pistons and pipes of hydraulic fluids, the object being to be able to operate an element in one direction and in the opposite direction.

To simplify the description and to retain the best embodiment, in particular the simplest, the most reliable and the least expensive, hereinafter an illustration is made with means 32 for operating by cables with a handle that rotates in the hanger, not shown, which is also the most instinctive.

The two control cables 32-1, 32-2 can be seen in the various figures as will be presented in detail further on, but they already appear in FIG. 2.

In FIGS. 3 and 4, the means 26 for changing chain wheels comprise a drum 34 of chain wheels that is mounted in rotation around an axis XX′.

This drum 34 of chain wheels has a track 36 with an established profile.

This track 36 receives a power finger 38, this power finger 38 being able to follow the profile of said track 36.

The power finger 38 is itself integral with a pin 40 carrying a fork 42, of known type, able to receive the chain 12 and to cause the derailing of said chain from one chain wheel to another.

The control is thus directly from the drum 34 of chain wheels to the fork 42.

The pin 40, supporting the fork 42, is mounted to move in translation and to be stationary in rotation relative to the case 20, this along an axis YY′ that is parallel to the axis XX′, i.e., approximately perpendicular to the plane of the frame.

This pin 40 is supplemented by a pin 40bis, perfectly parallel to the axis YY′, sliding in a stationary guide support, in this case the collar 22. This pin 40bis serves only as a guide to make possible a stable movement of the fork, without being rendered askew under the forces of friction on the chain, as will be explained further on during the description of the operation.

This drum 34 of chain wheels is extended by a double capstan 44 that constitutes a part of the operating means 32 and that receives the cables 32-1 and 32-2 with inverted windings. This is quite visible in FIG. 6.

The ends of the cables are held by cable clamps 38-1 and 38-2.

These operating means 32 further comprise an indexer 46 consisting of a disk 48 with notches 50 made on the periphery, uniformly distributed over this periphery. These notches 50 work with a pawl 52. This pawl 52 is of the type mounted to slide in a recessed housing 54, in a radial direction relative to said disk 48, subject to the force of a return spring 56 that tends to press said pawl in each notch 50 when one of the notches comes in line with said pawl, the notches and the pawl having matched profiles.

Advantageously, according to an improvement of this invention, the pawl 52 is mounted in the housing 54 with an angular play making it possible for said pawl to rock to accompany angularly the notch-carrying disk 48 over a limited area, notwithstanding the fact that a notch 50 works with the pawl. A return spring 58, for example a U-shaped blade spring, ensures the return to a centered position.

This makes possible the overshifting operation, i.e., the operation for exceeding a nominal level to facilitate the derailing by amplification of said derailing but going back to a perfectly centered nominal position, once the chain-wheel shifting is accomplished, as will be explained during the description of the operation.

The means 28 for changing sprockets comprises a slider 60, quite visible in FIGS. 3, 4 and 5, and a flange 62, integral with the drum 34 and therefore with the capstan 44, in disk form.

This slider 60 has an approximately vertical movement in translation, this slider being guided by the case 20 that has a suitable profile groove, not shown. The direction of movement ZZ′ of said slider is perpendicular to that of the approximately vertical axis XX′ of rotation of the drum 34.

The slider 60 moves in a plane parallel to that of the flange 62, along a diameter of the disk that constitutes said flange 62.

This slider comprises a head 64 and a body 66, the whole being provided with a central passage 68 intended to receive the cable 70 for operating the rear derailleur DR, immobilized in a known way by a cable clamp in line with the head.

The head 64 has two upper and lower guide pins, 72 and 74, which are monolithic with said head, placed one above the other along the axis ZZ′ of movement of the slider 60 and separated from one another by a distance d. The pins have a different length; in this case, the upper pin 72 has a length greater than that of the lower pin 74.

The body 66 is intended to receive a booster spring 76. This spring 76 has a length as great as possible to ensure the progressivity with a power such that it approximately offsets the power of the return spring of the rear derailleur DR, this when it is halfway compressed or stretched, as will be explained during the description of the operation of the device for shifting gears according to this invention.

The flange 62 has two outer and and inner tracks 78 and 80, in irregular spiral shape, approximately concentric relative to the axis of rotation XX′.

The outer track 78 is opening out on the periphery of the flange 62 while the inner track 80 is recessed.

The profile of the outer and inner tracks 78 and 80 is suited to the desired movements of the slider 60.

These two outer and and inner tracks 78 and 80 receive respectively the upper and lower pins 72 and 74.

These two outer and and inner tracks 78 and 80 have the special feature of being at different depths. The outer track 78 is deeper than the inner track 80, and they receive respectively the long upper pin 72 and the short lower pin 74.

Thus, a single pin works with a single track simultaneously.

The operation of the device 10 for shifting gears is now described with regard to an arrangement comprising two chain wheels A and B and five sprockets 1 to 5, the chain wheel A for the smaller, B for the larger, and 1 for the largest sprocket and 5 for the smallest sprocket.

The user is on the smallest gear by the combination A1.

For this gear, the operating means 32 have acted on the capstan 44 that has wound the cable 32-2, for example, and unwound the cable 32-1.

The position is then that of FIG. 3.

The operating finger 38 is moved from the side of the frame; therefore, the chain is forced onto the smallest chain wheel A.

The slider 60 is in top position with the lower pin 74 engaged and stopped in the inner track 80 while the upper pin 72 has left the outer and opening-out track 78. The cable 70 of the rear derailleur DR is stretched, in opposition to the return spring of said rear derailleur DR.

When the user exerts an action on the operating means 32, in the direction of an accelerator handle for example for a rotating handle, the cable 32-1 is wound and the cable 32-2 is unwound, and the capstan 44 rotates in a clockwise direction when it is seen in lateral elevation.

The drum 34 rotates and the approximately straight track 36 holds the fork 42 in place, so that the chain remains on the same small chain wheel A.

Simultaneously, the flange 62 rotates, and the inner guide track 80 that is oriented inward moves the slider 60 under the action of the pin 74 that is integral with it, so that the slider descends, releasing the cable 70 and allowing the rear derailleur DR to move, which causes the derailing of the chain from the sprocket 1 to the sprocket 2 leading to the gear A2.

It is noted that, simultaneously, the user is guided in his operation by the indexer 48 whose notches 50 work with the pawl 52.

When the user exerts a new action on the operating means 32, the cable 32-1 is again wound and the cable 32-2 is again unwound; the capstan 44 still rotates in a clockwise direction when it is seen in lateral elevation.

The drum 34 rotates and the approximately straight track 36 holds the fork 42 in place, so that the chain still remains on the same small chain wheel A.

Simultaneously, the flange 62 rotates, and the inner guide track 80 that is oriented inward moves the slider 60 under the action of the pin 74 that is integral with it, so that the slider again descends, releasing the cable 70 and allowing the rear derailleur DR to move, which causes the derailing of the chain from the sprocket 2 to the sprocket 3 leading to the gear A3.

The upper pin 72 is engaged in the outer guide track 78, without action.

The chain reaches the maximum desirable crossing.

It is noted that, simultaneously, the user is guided in his operation by the indexer 48 whose notches 50 again work with the pawl 52, the sensation always being the same for the user who feels the same “click.”

When the user exerts a third action on the operating means 32, the cable 32-1 is again wound and the cable 32-2 is again unwound, by the same length; the capstan 44 still rotates in a clockwise direction when it is seen in lateral elevation.

The drum 34 rotates, and the track 36 is now inclined. The power finger 38 is moved along the axis XX′, the pin 40 that is integral with it also moves and simultaneously moves the fork 42, so that the chain derails and goes from the small chain wheel A to the large chain wheel B.

Simultaneously, the flange 62 rotates, and the inner guide track 80 becomes deeper at this location so that the pin 74 no longer exerts action. The pin 72 is then guided by the outer track 78 that brings the slider 60 back toward the top. The slider 60 goes up and pulls on the cable 70 and guides the rear derailleur DR to move in the opposite direction, which causes the derailing of the chain from the sprocket 3 to the sprocket 2 leading to the gear B2.

Since moving from the small chain wheel A to the large chain wheel B causes a significant shifting of the gear, this shifting is attenuated by moving from a smaller sprocket 3 to a larger sprocket 2 so that the progressivity is maintained.

The chain finds a good alignment again.

It is noted that, simultaneously, the user is still guided in his operation by the indexer 48 whose notches 50 again work with the pawl 52, the sensation always being the same for the user who feels the same “click.”

The indexer like the capstan always rotates in the same direction.

When the user continues his action on the operating means 32, the assembly of the capstan 44, drum 34, indexer 48 and flange 62 rotates.

The pin 40 remains immobile in translation since the track 36 again becomes straight; the slider 38 moves in the track but without translation along the axis XX′; therefore, the fork 42 holds the chain on the chain wheel B.

In contrast, the pin 72, still engaged in the outer guide track 78, causes a movement of the slider toward the bottom, therefore a releasing of the cable 70 from the rear derailleur DR. The return spring of the rear derailleur causes the movement of the clevis of said rear derailleur DR and therefore the derailing of the chain from the sprocket 2 toward the sprocket 3. The combination B3 is obtained.

The chain is more and more aligned.

Any additional operation leads the chain to derail from a larger-diameter sprocket toward a smaller-diameter sprocket, increasing the gear through the combinations B4 and B5.

Thus, there is the progressive succession of the gears:
A1, A2, A3, B2, B3, B4, B5.

The device according to this invention makes it possible to obtain a progressivity as has been the case in the prior art but with the advantages linked to the particular arrangement.

In fact, it is understood that the fork 42 is directly operated without cable and without friction, unless it is that of the finger 38 in the track 36, which is insignificant. The elimination of the return spring of the fork that exists on the front derailleurs of the prior art, for moving from the larger chain wheel to the smaller chain wheel, is noted.

Thus, the front derailleur DA is different from those of the prior art, totally integrated into the case and with direct control, while eliminating any intermediate cable, any return spring except to provide an optional booster spring in line with the pins 40 and/or 40bis.

The double-winding capstan 44 still works by pulling, which is most efficient in the opposite direction of the single cables working by push/pull, which must have a rather large diameter and whose friction is elevated.

These cables 32-1 and 32-2 come almost directly from the hanger and require only very few curves, additionally with a large radius of curvature and therefore not detrimental.

As for the rear derailleur DR, the operating cable 70 is almost direct since it comes out of the case 20 to reach the rear derailleur with a simple S having large radii of curvature.

Here again, the friction is minimal.

Therefore, there is only very slight unwanted friction, which leads to an easy and effortless use of the means 32 for operation without difficulty by the user who may be a child.

From the standpoint of bulk, the tracks 78 and 80 having different depths made on the flange 62 and the slider having two pins 72 and 74 make possible a certain compactness, allowing the mounting of the device on all of the types of bicycle frames.

It is also noted that the case can advantageously be made of resin for molding opportunities, for reasons of cost, and for reasons of weight.

The device according to this invention also allows the mounting on the two large types of bicycles, without suspension or suspended. In fact, the cable 70 can come out toward the top or toward the bottom according to requirements, this with the same parts; it suffices to have the associated elements pivot by 180°, namely the flange 62, the slider 60 with its booster spring 76, and the corresponding part of the case 20 relative to the drum 34.

The exit point of the cable 70 can therefore be oriented toward the top or toward the bottom to go above or below the rear arm.

The reduced number of parts is noted, and the resultant reliability is deduced from that.

The maintenance actions are reduced, and, advantageously, bellows can be added to protect the pins 40 and 40bis that can move in translation, for example.

The different rotating parts work on their periphery, therefore with maximum torques for a minimum bulkiness of the case.

In the case of the guide tracks 78 and 80, the torque is maximal on the slider for the lifting of the chain onto the larger-diameter sprockets.

1. Single device for shifting gears on a bicycle equipped with chain wheels (14) and sprockets (16), a chain (12) stretched between these chain wheels and sprockets as well as a rear derailleur DR, said single device for shifting gears comprising a single case (20) incorporating:
means (26) for changing wheel chains with direct control of a fork (42), forming front derailleur DA, means (28) for changing sprockets via the rear derailleur DR, and
means (30) for control of said means (26) for changing chain wheels and of said means (28) for changing sprockets.

2. Single device for shifting gears on a bicycle according to claim 1, characterized in that it comprises means (32) for operating the control means (30), these operating means (32) comprising two operated cables (32-1, 32-2), and a capstan (44) intended to receive the two cables with inverted windings.

3. Single device for shifting gears on a bicycle according to claim 2, wherein these operating means (32) comprise an indexer (46) consisting of a disk (48) with notches (50) made on the periphery, a pawl (52) of the type mounted to slide in a recessed housing (54) in a radial direction relative to said disk (48), subject to the force of a return spring (56).

4. Single device for shifting gears on a bicycle according to claim 3, wherein the pawl (52) is mounted in the housing (54) with an angular play making it possible for said pawl to rock to accompany angularly the disk (48) carrying notches (50) and comprises a return spring (58), for example a U-shaped blade spring to ensure the return to a centered position.

5. Single device for shifting gears on a bicycle according to claim 1, wherein the means (26) for changing chain wheels comprise a drum (34) of chain wheels, mounted in rotation around an axis XX′, a track (36) having an established profile made in said drum, a power finger (38) able to follow the profile of said track (36), this finger being integral with a pin (40) carrying a fork (42) able to receive the chain (12) and to cause the derailing of said chain from one chain wheel to another.

6. Single device for shifting gears on a bicycle according to claim 5, wherein the pin (40), supporting the fork (42), is mounted to move in translation and to be stationary in rotation relative to the case (20), along an axis YY′ that is parallel to the axis XX′.

7. Single device for shifting gears on a bicycle according to claim 2, wherein the means (28) for changing sprockets comprise a slider (60), a flange (62) integral with the capstan (44), said slider (60) being movable in translation in a direction of movement ZZ′, in a plane parallel to that of the flange (62), the slider (60) comprising two upper and lower guide pins (72, 74), and the flange comprising two outer and inner tracks (78 and 80) able to work with said pins.

8. Single device for shifting gears on a bicycle according to claim 7, wherein the pins (72, 74) have different lengths and the tracks (78, 80) have different depths so that a single pin works with a single track at the same time.

9. Single device for shifting gears on a bicycle according to claim 7, wherein the slider (60) comprises a head (64) and a body (66), the whole being provided with a central passage (68) intended to receive the cable (70) for operating the rear derailleur DR.

10. Single device for shifting gears on a bicycle according to claim 9, wherein the body (66) receives a booster spring (76).

11. Single device for shifting gears on a bicycle according to claim 1, wherein a part of the case (20) and the associated elements can be pivoted by 180° to have an exit toward the top or toward the bottom.

12. Single device for shifting gears on a bicycle according to claim 2, wherein the means (26) for changing chain wheels comprise a drum (34) of chain wheels, mounted in rotation around an axis XX′, a track (36) having an established profile made in said drum, a power finger (38) able to follow the profile of said track (36), this finger being integral with a pin (40) carrying a fork (42) able to receive the chain (12) and to cause the derailing of said chain from one chain wheel to another.

13. Single device for shifting gears on a bicycle according to claim 3, wherein the means (26) for changing chain wheels comprise a drum (34) of chain wheels, mounted in rotation around an axis XX′, a track (36) having an established profile made in said drum, a power finger (38) able to follow the profile of said track (36), this finger being integral with a pin (40) carrying a fork (42) able to receive the chain (12) and to cause the derailing of said chain from one chain wheel to another.

14. Single device for shifting gears on a bicycle according to claim 4, wherein the means (26) for changing chain wheels comprise a drum (34) of chain wheels, mounted in rotation around an axis XX′, a track (36) having an established profile made in said drum, a power finger (38) able to follow the profile of said track (36), this finger being integral with a pin (40) carrying a fork (42) able to receive the chain (12) and to cause the derailing of said chain from one chain wheel to another.

15. Single device for shifting gears on a bicycle according to claim 3, wherein the means (28) for changing sprockets comprise a slider (60), a flange (62) integral with the capstan (44), said slider (60) being movable in translation in a direction of movement ZZ′, in a plane parallel to that of the flange (62), the slider (60) comprising two upper and lower guide pins (72, 74), and the flange comprising two outer and inner tracks (78 and 80) able to work with said pins.

16. Single device for shifting gears on a bicycle according to claim 4, wherein the means (28) for changing sprockets comprise a slider (60), a flange (62) integral with the capstan (44), said slider (60) being movable in translation in a direction of movement ZZ′, in a plane parallel to that of the flange (62), the slider (60) comprising two upper and lower guide pins (72, 74), and the flange comprising two outer and inner tracks (78 and 80) able to work with said pins.

17. Single device for shifting gears on a bicycle according to claim 5, wherein the means (28) for changing sprockets comprise a slider (60), a flange (62) integral with the capstan (44), said slider (60) being movable in translation in a direction of movement ZZ′, in a plane parallel to that of the flange (62), the slider (60) comprising two upper and lower guide pins (72, 74), and the flange comprising two outer and inner tracks (78 and 80) able to work with said pins.

18. Single device for shifting gears on a bicycle according to claim 6, wherein the means (28) for changing sprockets comprise a slider (60), a flange (62) integral with the capstan (44), said slider (60) being movable in translation in a direction of movement ZZ′, in a plane parallel to that of the flange (62), the slider (60) comprising two upper and lower guide pins (72, 74), and the flange comprising two outer and inner tracks (78 and 80) able to work with said pins.

19. Single device for shifting gears on a bicycle according to claim 8, wherein the slider (60) comprises a head (64) and a body (66), the whole being provided with a central passage (68) intended to receive the cable (70) for operating the rear derailleur DR.

20. Single device for shifting gears on a bicycle according to claim 19, wherein the body (66) receives a booster spring (76).
